(19) United States
(12) Patent Application Publication
(10) Pub. No.: US 2018/0147895 A1
(43) Pub. Date: May 31, 2018

(54) PNEUMATIC TIRE

(71) Applicant: TOYO TIRE & RUBBER CO., LTD., Itami-shi (JP)

(72) Inventor: Harunobu Suita, Itami-shi (JP)

(73) Assignee: TOYO TIRE & RUBBER CO., LTD., Itami-shi (JP)

(21) Appl. No.: 15/679,393

(22) Filed: Aug. 17, 2017

(30) Foreign Application Priority Data
Nov. 25, 2016 (JP) 2016-229255

(51) Int. Cl. B60C 13/02; B60C 11/01

(52) U.S. Cl. CPC B60C 13/02; B60C 2011/0348; B60C 2011/013; B60C 11/01

(57) ABSTRACT

A pneumatic tire in accordance with the present disclosure is provided with tread comprising shoulder lug provided with narrow groove. Shoulder lug comprises main lug portion, which comprises first arc, second arc and line segment. First arc constitutes a portion of a tread surface at tread. Line segment constitutes a portion of a wall face at narrow groove. Second arc connects first arc and line segment. Line passes through point common to first arc and second arc and is disposed at a location toward the interior in the tire width direction. Narrow groove comprises first region and second region. Second region is of curved shape, the curvature being such as to bring it closer to the tire equatorial plane as the depth thereof increases.

### TECHNICAL FIELD

The present disclosure relates to a pneumatic tire that is provided with defense groove(s) (hereinafter “narrow groove(s)”).

### BACKGROUND ART

At a running pneumatic tire, contact patch pressure at shoulder lugs on the tread surface in the vicinity of the edge of the contact patch being high, the amount of wear at shoulder lugs in the vicinity of the edge of the contact patch is ordinarily greater than at lugs elsewhere on the tread surface.

To prevent such uneven wear, shoulder lugs are sometimes provided with narrow grooves which extend in the tire circumferential direction and which, as viewed in a section in the tire width direction, extend radially in straight fashion. The narrow grooves cause shoulder lugs to be divided into main lug portions toward the interior in the tire width direction from the narrow groove, and sacrificial lug portions toward the exterior in the tire width direction from the narrow groove, as a result of which wear of the main lug portions is suppressed.

### PRIOR ART REFERENCES

### Patent References

### PATENT REFERENCE NO. 1: Japanese Patent Application Publication Kokai No. 2014-213835

### PATENT REFERENCE NO. 2: Japanese Patent Application Publication Kokai No. 2002-79809

PATENT REFERENCE NO. 3: Japanese Patent Application Publication Kokai No. H3[1991]-7604

### SUMMARY OF INVENTION

### Problem to be Solved by Invention

However, even where a narrow groove of such configuration is provided, contact patch pressure at the region of the main lug portion in the vicinity of the narrow groove (hereinafter “main lug portion edge”) will be high, and there will be a large amount of wear in this region.

The present disclosure was conceived in light of such situation, it being an object thereof to provide a pneumatic tire having improved resistance to uneven wear.

### Means for Solving Problem

A pneumatic tire in accordance with the present disclosure is provided with a tread comprising a shoulder lug extending in a tire circumferential direction;

wherein the shoulder lug is equipped with a narrow groove extending in the tire circumferential direction;

the shoulder lug comprises a main lug portion which is disposed at a location toward the interior in the tire width direction from the narrow groove;

an outline of the main lug portion as viewed in a section in the tire width direction comprises a first arc, a second arc, and a line segment;

the first arc extends in the tire width direction and constitutes a portion of a tread surface at the tread;

the line segment extends in the tire radial direction and constitutes a portion of a wall face at the narrow groove;

the second arc connects the first arc and the line segment;

a line which is normal to the first arc and which passes through a point common to the first arc and the second arc is disposed at a location toward the interior in the tire width direction from an imaginary line which is parallel to the normal line and which passes through a point common to the second arc and the line segment;

the narrow groove comprises a first region which extends in parallel fashion with respect to the line segment, and a second region which is disposed at a location deeper than the first region;

as viewed in a section in the tire width direction, the second region is of curved shape, curving in such fashion as to cause distance to a tire equatorial plane to decrease with increasing depth; and

taking a distance between the normal line and the imaginary line to be WR, and taking a shortest distance between a deepest point in the tire width direction of the second region and the imaginary line to be WD, a ratio of WR to WD is in a range 0.7 to 1.3.

In accordance with the present disclosure, because the shoulder lug is provided with a narrow groove that comprises a first region which extends in parallel fashion with respect to the line segment, and a second region which is of curved shape, curving in such fashion as to cause distance to a tire equatorial plane to decrease with increasing depth, it is possible to reduce contact patch pressure at main lug portion edges. Furthermore, because the side crest of the main lug portion is made to gradually decline in height as a result of the fact that the second arc connects the first arc which extends in the tire width direction and the line segment which extends in the tire radial direction, it is possible to even further reduce contact patch pressure at main lug portion edges. Moreover, because the ratio of WR to WD is in the range 0.7 to 1.3, it is possible to ensure the rigidity of the main lug portion. The present disclosure therefore makes it possible to effectively reduce contact patch pressure at main lug portion edges, to make contact patch pressure at the shoulder lug more uniform, and to improve resistance to uneven wear.

At a pneumatic tire in accordance with the present disclosure, it is preferred that an outline of the second region as viewed in a section in the tire width direction not comprise any corners. This is so as to make it possible to distribute strain that might otherwise become concentrated at groove bottom(s) and so as to permit improvement in resistance to cracking at groove bottom(s).

### BRIEF DESCRIPTION OF DRAWINGS

FIG. 1 Drawing showing section in the tire width direction of a shoulder lug at a pneumatic tire in accordance with a first embodiment.

FIG. 2 Drawing showing section in the tire width direction of a shoulder lug in a test tire at Comparative Example 1.

FIG. 3 Drawing showing section in the tire width direction of a shoulder lug in a test tire at Comparative Example 2.

### EMBODIMENTS FOR CARRYING OUT INVENTION

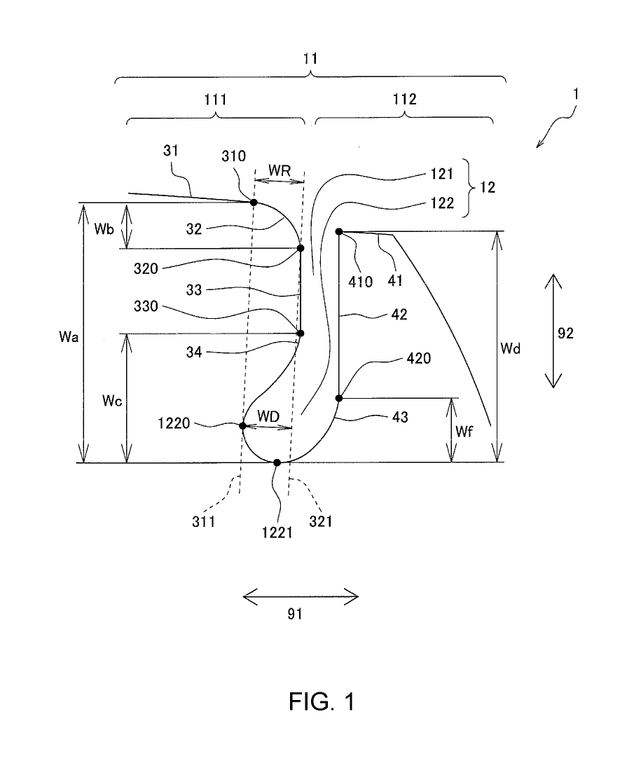

A first embodiment in accordance with the present disclosure is described below. At FIG. 1, 91 indicates the tire width direction. The tire width direction is the direction which is perpendicular to the equatorial plane of the tire. 92 indicates the tire radial direction. A “section in the tire width direction” is a section cut straight through the pneumatic tire in such fashion as to pass through the two ends of the rotational axis of the tire.

As shown in FIG. 1, a pneumatic tire in accordance with a first embodiment is provided with tread 1 comprising a shoulder lug 11 extending in the tire circumferential direction. Shoulder lug 11 is provided with narrow groove 12 extending in the tire circumferential direction. Although not shown in FIG. 1, tread 1 is provided with major groove(s) extending in the tire circumferential direction at location(s) toward the interior in the tire width direction from shoulder lug 11. Width of the major groove(s) is greater than width of narrow groove(s) 12. Width of the major groove(s) might, for example, be 5 mm to 20 mm.

Shoulder lug 11 comprises main lug portion(s) 111 disposed at location(s) toward the interior in the tire width direction from narrow groove(s) 12. The outline of main lug portion 111, as viewed in a section in the tire width direction, comprises first arc 31, second arc 32, and line segment 33. The outline of main lug portion 111 further comprises third arc 34.

Line 311 which is normal to first arc 31 and which passes through point 310 common to first arc 31 and second arc 32 is disposed at a location toward the interior in the tire width direction from imaginary line 321 which is parallel to normal 311 and which passes through point 320 common to second arc 32 and line segment 33.

Distance WR between normal 311 and imaginary line 321 might, for example, be not less than 1 mm, it being preferred that this be not less than 2 mm. The upper limit of the range in values for WR might, for example, be 5 mm, it being preferred that this be 4 mm.

First arc 31 constitutes a portion of the tread surface at tread 1. While not exactly linear, first arc 31 is very nearly so as it describes the locus of an arc extending in the tire width direction. Radius of curvature of first arc 31 is greater than radius of curvature of second arc 32. Radius of curvature of first arc 31 might, for example, be not less than 400 mm. Length of first arc 31 might, for example, be not less than 30 mm. The upper limit of the range in values for the length of first arc 31 might, for example, be 60 mm. The center of curvature of first arc 31 may be disposed at a location toward the interior in the tire radial direction from an imaginary line which is the extension of first arc 31 to the tire equatorial plane.

Second arc 32 connects first arc 31 and line segment 33 in such fashion as to cause the side crest of main lug portion 111 to gradually decline in height. Radius of curvature of second arc 32 might, for example, be not less than 3 mm. The upper limit of the range in values for the radius of curvature of second arc 32 might, for example, be 6 mm. Length of second arc 32 might, for example, be not less than 4 mm. The upper limit of the range in values for the length of second arc 32 might, for example, be 5 mm. The center of curvature of second arc 32 may be disposed at a location toward the interior in the tire width direction from an imaginary line extending in the tire radial direction and passing through common point 310.

Line segment 33 constitutes a portion of a wall face at narrow groove 12. Line segment 33 connects second arc 32 and third arc 34. Line segment 33 extends in the tire radial direction. When it is said here that “line segment 33 extends in the tire radial direction,” this includes both the situation in which line segment 33 extends so as not to be inclined with respect to the tire radial direction, and the situation in which line segment 33 extends so as to be inclined with respect to the tire radial direction. Where line segment 33 extends so as to be inclined with respect to the tire radial direction, the angle of inclination of line segment 33 with respect to the tire radial direction is within the range ±7°. At FIG. 1, line segment 33 extends so as not to be inclined with respect to the tire radial direction. Length of line segment 33 might, for example, be not less than 3 mm. The upper limit of the range in values for the length of line segment 33 might, for example, be 4 mm.

Third arc 34 constitutes a portion of a wall face at narrow groove 12. Third arc 34 extends toward the tire equatorial plane from the inner end in the tire radial direction of line segment 33. It is preferred that the radius of curvature of third arc 34 be greater than the radius of curvature of second arc 32. Radius of curvature of third arc 34 might, for example, be not less than 4 mm. The upper limit of the range in values for the radius of curvature of third arc 34 might, for example, be 8 mm. Length of third arc 34 might, for example, be not less than 4 mm. The upper limit of the range in values for the length of third arc 34 might, for example, be 5 mm. The center of curvature of third arc 34 may be disposed at a location toward the interior in the tire width direction from an imaginary line extending in the tire radial direction and passing through common point 310.

Narrow groove 12 comprises first region 121 extending in parallel fashion with respect to line segment 33 and second region 122 which is disposed at a location deeper than first region 121 in the tire radial direction. As viewed in a section in the tire width direction, second region 122 is of curved shape, the curvature being such as to bring it closer to the tire equatorial plane as the depth thereof increases. It is preferred that second region 122 have a portion at which width increases with increasing depth. It is preferred that the outline of second region 122 not comprise any corners as viewed in a section in the tire width direction. Moreover, it is preferred that the outline of the bottom of narrow groove 12 as viewed in a section in the tire width direction be rounded, and more preferred that this be made up of a single arc. The deepest point 1220 in the tire width direction of the second region 122 is disposed at a location toward the interior in the tire width direction from imaginary line 321.

The shortest distance WD between the deepest point 1220 in the tire width direction of the second region 122 and imaginary line 321 might, for example, be not less than 1 mm, it being preferred that this be not less than 2 mm. The upper limit of the range in values for WD might, for example, be 5 mm, it being preferred that this be 4 mm. Above this upper limit, rigidity of main lug portion 111 may be low.

It is preferred that the ratio of WR to WD (i.e., WR/WD) be in the range 0.7 to 1.3. Below 0.7, there is a tendency for the rigidity of main lug portion 111 to decrease. Above 1.3, there tends to be little benefit in terms of improvement in resistance to uneven wear.

The ratio of WR to the width of main lug portion 111 (i.e., WR/main lug portion 111 width) might, for example, be not less than 0.01. The upper limit of the range in values thereof might, for example, be not greater than 0.5 mm. If the two ends of first arc 31 are defined as a first end and a second end that constitutes common point 310, the width of main lug portion 111 may be defined as the distance between imaginary line 321 and a line drawn parallel to imaginary line 321 and passing through the first end.

Distance Wa between an imaginary line extending in the tire width direction and passing through common point 310, and an imaginary line extending in the tire width direction and passing through the deepest point 1221 in the tire radial direction of narrow groove 12, might, for example, be 8 mm to 16 mm. The value of Wa may be the same or nearly the same as the depth of the major groove.

Distance Wb between an imaginary line extending in the tire width direction and passing through common point 310, and an imaginary line extending in the tire width direction and passing through common point 320, might, for example, be 1 mm to 4 mm.

Distance We between an imaginary line extending in the tire width direction and passing through point 330 common to third arc 34 and line segment 33, and an imaginary line extending in the tire width direction and passing through the deepest point 1221 in the tire radial direction of narrow groove 12, might, for example, be 4 mm to 8 mm.

The ratio of the sum of Wb and We to Wa (i.e., (Wb+Wc)/Wa) might, for example, be in the range 0.5 to 1.5.

Shoulder lug 11 further comprises sacrificial lug portion(s) 112 disposed at location(s) toward the exterior in the tire width direction from narrow groove(s) 12. The outline of sacrificial lug portion 112, as viewed in a section in the tire width direction, comprises first arc 41, line segment 42, and second arc 43.

The outline of sacrificial lug portion 112 comprises first arc 41. While not exactly linear, first arc 41 is very nearly so as it describes the locus of an arc extending in the tire width direction. It is preferred that first arc 41 be offset from first arc 31. By this it is meant at least that first arc 41 and an imaginary line which is the extension of first arc 31 into the region above sacrificial lug portion 112 do not mutually intersect. The preferred range of values for the radius of curvature of first arc 41 is the same as that of first arc 31. Length of first arc 41 might, for example, be not less than 2 mm. The upper limit of the range in values for the length of first arc 41 might, for example, be 10 mm. The center of curvature of first arc 41 may be disposed at a location toward the interior in the tire radial direction from an imaginary line which is the extension of first arc 41 to the tire equatorial plane.

The outline of sacrificial lug portion 112 comprises line segment 42. Line segment 42 constitutes a portion of a wall face at narrow groove 12. Line segment 42 connects first arc 41 and second arc 43. Line segment 42 extends in the tire radial direction. When it is said here that “line segment 42 extends in the tire radial direction,” this includes both the situation in which line segment 42 extends so as not to be inclined with respect to the tire radial direction, and the situation in which line segment 42 extends so as to be inclined with respect to the tire radial direction. Where line segment 42 extends so as to be inclined with respect to the tire radial direction, the angle of inclination of line segment 42 with respect to the tire radial direction is within the range ±7°. Line segment 42 may be parallel to line segment 33. It is preferred that line segment 42 be longer than line segment 33.

The outline of sacrificial lug portion 112 comprises second arc 43. Second arc 43 constitutes a portion of a wall face at narrow groove 12. Second arc 43 extends toward the tire equatorial plane from the inner end in the tire radial direction of line segment 42. It is preferred that the radius of curvature of second arc 43 be larger than the radius of curvature of third arc 34. Radius of curvature of second arc 43 might, for example, be not less than 5 mm. The upper limit of the range in values for the radius of curvature of second arc 43 might, for example, be 9 mm. Length of second arc 43 might, for example, be not less than 4 mm. The upper limit of the range in values for the length of second arc 43 might, for example, be 6 mm. The center of curvature of second arc 43 may be disposed at a location toward the interior in the tire width direction from an imaginary line extending in the tire radial direction and passing through the deepest point 1221 in the tire radial direction.

When line segment 42 is parallel to line segment 33, the distance between line segment 33 and line segment 42 might, for example, be 1 mm to 5 mm.

Distance Wd between an imaginary line extending in the tire width direction and passing through point 410 common to first arc 41 and line segment 42, and an imaginary line extending in the tire width direction and passing through the deepest point 1221 in the tire radial direction of narrow groove 12, might, for example, be 10 mm to 14 mm.

Distance Wf between an imaginary line extending in the tire width direction and passing through point 420 common to line segment 42 and second arc 43, and an imaginary line extending in the tire width direction and passing through the deepest point 1221 in the tire radial direction of narrow groove 12, might, for example, be 3 mm to 7 mm.

The ratio of Wf to Wd (i.e., Wf/Wd) might, for example, be in the range 0.2 to 0.7.

It is preferred that the pneumatic tire of the first embodiment be capable of being employed as a pneumatic tire intended for heavy loads.

### WORKING EXAMPLES

Working examples and the like which illustrate the constitution and effect of the present invention in specific terms are described below.

### Working Example 1

This was a test tire (295/75R22.5) having the configuration shown in FIG. 1. At the test tire of Working Example 1, WR was 2.8 mm, and WD was 2.8 mm.

### Working Example 2

Except for the fact that WR was 2 mm, this was identical to the test tire of Working Example 1.

### Working Example 3

Except for the fact that WR was 3.7 mm, this was identical to the test tire of Working Example 1.

### Comparative Example 1

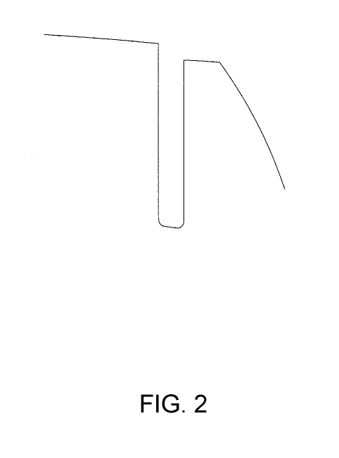

This was a test tire having the configuration shown in FIG. 2. Except for the fact that second arc 32 was not present, the fact that first arc 31 extended into the region above line segment 33 and line segment 33 extended into the region thereabove, and the fact that, as viewed in a section in the tire width direction, the narrow groove extended in straight fashion in the tire radial direction, the test tire of Comparative Example 1 was identical to that of Working Example 1.

### Comparative Example 2

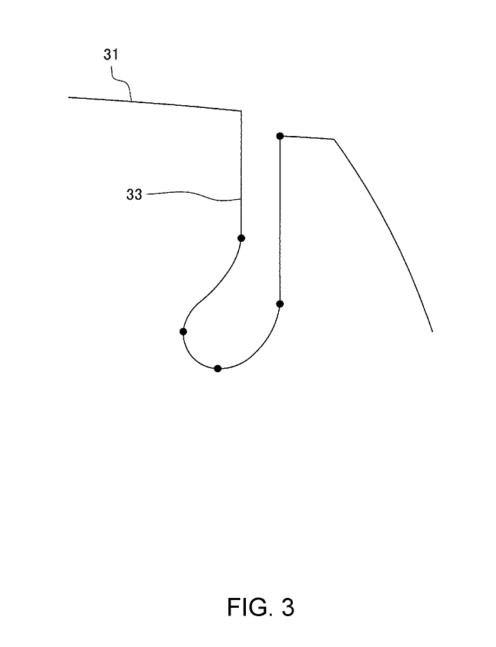

This was a test tire having the configuration shown in FIG. 3. Except for the fact that second arc 32 was not present, and the fact that first arc 31 extended into the region above line segment 33 and line segment 33 extended into the region thereabove, the test tire of Comparative Example 2 was identical to that of Working Example 1.

### Comparative Example 3

Except for the fact that WR was 1.6 mm, this was identical to the test tire of Working Example 1.

### Comparative Example 4

Except for the fact that WR was 4 mm, this was identical to the test tire of Working Example 1.

### Resistance to Uneven Wear

A tire having a tire size of 295/75R22.5 was assembled onto a wheel of rim size 22.5×8.25, and testing was carried out by causing this to be run under conditions of 760 kPa air pressure (internal pressure as specified by TRA), 80 km/h speed, and 27.5 kN load (TRA 100% load). The ratio between the amount of wear at the center rib (hereinafter “Ce”) and at the shoulder rib (hereinafter “Sh”) is shown at TABLE 1. When Sh>Ce, Sh/Ce is shown with a positive value to indicate that there was greater wear at the shoulder; when Ce>Sh, Ce/Sh is shown with a negative value to indicate that there was greater wear at the center; and when Sh=Ce, this is shown as 1.0 to indicate that wear was uniform. 1.0 is preferred.

### Resistance to Cracking at Groove Bottom

A drum-type apparatus was used to carry out testing under conditions of 295/75R22.5 tire size, 22.5×8.25 rim size, 760 kPa air pressure, 60 km/h speed, and 21.8 kN load. Crack width at the groove bottom after 15000 km of travel was measured. Crack width at the groove bottom for the respective examples is shown indexed relative to a value of 100 for the crack width at the groove bottom for Comparative Example 1. The larger the value the smaller the crack width at the groove bottom and the more excellent the resistance to cracking at the groove bottom.

TABLE 1

| | Comparative | Comparative | Comparative | Comparative | Working | Working | Working |
|---|---|---|---|---|---|---|---|
| | Example 1 | Example 2 | Example 3 | Example 4 | Example 1 | Example 2 | Example 3 |
| Shape of cross- | Straight | Curved | Curved | Curved | Curved | Curved | Curved |
| section of narrow | | | | | | | |
| groove | | | | | | | |
| Second nrc | Absent | Absent | Present | Present | Present | Present | Present |
| WR | — | — | 1.6 | 4 | 2.8 | 2 | 3.7 |
| WD | — | 2.8 | 2.8 | 2.8 | 2.8 | 2.8 | 2.8 |
| WR/WD | — | — | 0.6 | 1.4 | 1.0 | 0.7 | 1.3 |
| Resistance to uneven | 1.8 | 1.6 | 1.5 | 1.5 | 1.0 | 1.2 | 1.2 |
| wear | | | | | | | |
| Resistance to | 100 | 110 | 112 | 112 | 120 | 115 | 115 |
| cracking at groove | | | | | | | |
| bottom | | | | | | | |

Causing second arc 32 to connect first arc 31 and line segment 33, removing the corners at the deepest portion of narrow groove 12, and causing the deepest portion of narrow groove 12 to be curved improved resistance to uneven wear and/or resistance to cracking at the groove bottom (see Comparative Example 1 and Working Examples 1 through 3). However, when WR/WD was 0.6, there was little benefit in terms of improvement thereof (see Comparative Example 3). And when WR/WD was 1.4, there was little benefit in terms of improvement thereof (see Comparative Example 4).

1. A pneumatic tire provided with a tread comprising a shoulder lug extending in a tire circumferential direction;
wherein the shoulder lug is equipped with a narrow groove extending in the tire circumferential direction;
the shoulder lug comprises a main lug portion which is disposed at a location toward the interior in the tire width direction from the narrow groove;
an outline of the main lug portion as viewed in a section in the tire width direction comprises a first arc, a second arc, and a line segment;
the first arc extends in the tire width direction and constitutes a portion of a tread surface at the tread;
the line segment extends in the tire radial direction and constitutes a portion of a wall face at the narrow groove;
the second arc connects the first arc and the line segment;
a line which is normal to the first arc and which passes through a point common to the first arc and the second arc is disposed at a location toward the interior in the tire width direction from an imaginary line which is parallel to the normal line and which passes through a point common to the second arc and the line segment;
the narrow groove comprises a first region which extends in parallel fashion with respect to the line segment, and a second region which is disposed at a location deeper than the first region;
as viewed in a section in the tire width direction, the second region is of curved shape, curving in such fashion as to cause distance to a tire equatorial plane to decrease with increasing depth; and
taking a distance between the normal line and the imaginary line to be WR, and taking a shortest distance between a deepest point in the tire width direction of the second region and the imaginary line to be WD, a ratio of WR to WD is in a range 0.7 to 1.3.

2. The pneumatic tire according to claim 1 wherein an outline of the second region as viewed in a section in the tire width direction does not comprise any corners.

3. The pneumatic tire according to claim 1 wherein WR is not less than 1 mm.

4. The pneumatic tire according to claim 1 wherein an upper limit of the range in values for WR is 5 mm.

5. The pneumatic tire according to claim 1 wherein a radius of curvature of the first arc is greater than a radius of curvature of the second arc.

6. The pneumatic tire according to claim 1 wherein a radius of curvature of the first arc is not less than 400 mm.

7. The pneumatic tire according to claim 1 wherein an upper limit of the range in values for a radius of curvature of the second arc is 6 mm.

8. The pneumatic tire according to claim 1 wherein the second region has a portion at which width increases with increasing depth.

9. The pneumatic tire according to claim 1 wherein a length of the first arc is not less than 30 mm.

10. The pneumatic tire according to claim 1 wherein an upper limit of the range in values for a length of the first arc is 60 mm.

11. The pneumatic tire according to claim 1 wherein a length of the second arc is not less than 4 mm.

12. The pneumatic tire according to claim 1 wherein an upper limit of the range in values for a length of the second arc is 5 mm.
